(19) United States
(12) Patent Application Publication
(10) Pub. No.: US 2009/0323245 A1
(43) Pub. Date: Dec. 31, 2009

(54) Device for Reduction of Voltage Derivative

(75) Inventors: Lars Liljestrand, Vasteras (SE); Magnus Backman, Vasteras (SE)

Correspondence Address: VENABLE LLP, P.O. BOX 34385, WASHINGTON, DC, 20043-9998, US

(73) Assignee: ABB Technology Ltd., Zurich (CH)

(21) Appl. No.: 11/919,521

(22) PCT Filed: Apr. 27, 2006
(86) PCT No.: PCT/SE2006/000516

§ 371 Date: Feb. 17, 2009

(30) Foreign Application Priority Data
Apr. 27, 2005 (SE) 0500960-0

(51) Int. Cl. H02H 3/22

(52) U.S. Cl. 361/111

(57) ABSTRACT

A device for reduction of the voltage derivative for an electrical component connected to an electric conductor via an electric bushing. The device protects an electrical component in an electrical apparatus against high voltage derivatives.

### TECHNICAL FIELD

The present invention relates to a device for reduction of the voltage derivative for an electrical component connected to an electric conductor via an electric bushing. The device is intended for protecting an electrical component in an electrical apparatus, such as a transformer, a reactor, a high-voltage circuit breaker, a motor, or a generator, against high voltage derivatives. The invention is particularly suited for electrical apparatus intended for voltages above 1 kV.

### BACKGROUND ART

In the transmission of high-voltage current to electrical apparatuses, such as transformers, reactors, high-voltage circuit breakers, generators and motors, transient overvoltages may sometimes occur in the conductor that transmits the current to said apparatuses. Such a transient may be caused by, for example, a lightning stroke in the electric conductor that transits the current to the electrical apparatus. The electrical apparatus then runs a considerable risk of being damaged by the high voltage derivative (du/dt) that arises as a result of the transient. Thus, it is of the utmost importance to attempt to prevent such an event.

For electrical apparatuses comprising windings, for example transformers, reactors, motors or generators, problems arise when a rapid transient occurs since the uppermost turns in the winding of the apparatus are more stressed by the rapid transient than are the underlying turns. The consequence of this is a non-uniform voltage distribution across the turns. This means that the uppermost turns are subjected to higher stresses compared with the underlying turns. This stressing of the uppermost turns entails a considerable risk of the winding being damaged, with breakdown of the electrical apparatus as a direct consequence thereof. The winding must thus be designed to withstand this stressing. A breakdown entails, inter alia, a risk of power failure, negative environmental impact as well as the repair costs associated therewith. It is already known that, in a transformer, an increase in capacitance is achieved between the uppermost turns of the winding by opening the insulation of the existing winding on the uppermost turns, and then allowing the turns to be modified, so-called stabilized winding, whereupon the insulation is restored. In this way, a high capacitance may be achieved between the turns of the winding as well as low capacitance to ground, thus achieving protection against rapid transients. The disadvantage of this is that the winding is oversized, the manufacturing process for the winding is time-consuming and cost-demanding, and that even after the capacitance increase there is a risk of electrical breakdown where the insulation once has been opened.

Furthermore, it is previously known to eliminate the problem that arises when a rapid transient occurs with the aid of a surge arrester and a protective capacitor connected in parallel therewith between the conductor and ground. Optimal protection against transient overvoltages comprises a surge arrester and a protective capacitor connected phase-to-ground or phase-to-phase. A surge arrester limits the amplitude (U) of the transient overvoltage and the protective capacitor limits the voltage derivative (du/dt) of the transient overvoltage. By surge arrester is meant a very non-linear resistor that limits the voltage to a certain level. However, the solution requires two separate components, surge arrester and protective capacitor, installed outside the transformer.

Also for electrical apparatus such as, for example, high-voltage circuit breakers, problems will arise when they are subjected to transient overvoltages, which may occur, for example, upon a rapid breaker operation. There is then a risk that the high voltage derivative (du/dt) will make it impossible for the arcing contacts of the breaker to break the current. One consequence of this is inferior breaking performance by the circuit breaker. Another consequence that may ensue is that the circuit breaker simply suffers a total breakdown if it is not capable of breaking the current. It is thus of the utmost importance to attempt to reduce the voltage derivative (du/dt) in order thus to obtain improved breaking capacity of the circuit breaker.

It is previously known to manufacture high-voltage circuit breakers up to 300 kV with an interrupting chamber, and to enable interrupting higher voltages several interrupting chambers are connected in series. To ensure a good voltage distribution across the interrupting chambers in the open position, control capacitors are used in parallel over each breaking point to capacitively control the voltage distribution. These control capacitors are usually external, separate capacitors that are connected outside the interrupting-chamber insulants. There are also solutions where the capacitor is located inside the interrupting-chamber insulant, and this method is described, inter alia, in U.S. Pat. No. 6,091,040. It is also previously known to protect a high-voltage circuit breaker against rapid transients by using a coupling capacitor that is connected phase-to-ground on the line side of the circuit breaker. This capacitor reduces the steepness of the recovery voltage and therefore reduces the stress on the circuit breaker. The coupling capacitor is connected externally in a separate insulant. To achieve the same effect as described above, it is also known to install a protective capacitor in the casing of the circuit breaker, and this process is described, inter alia, in U.S. Pat. No. 3,903,388 and U.S. Pat. No. 5,266,758. Another method that is used to protect a circuit breaker from rapid transients is described in U.S. Pat. No. 5,235,147, where a capacitor and a varistor are connected in series with a resistor and are arranged inside the casing of the circuit breaker.

A bushing is used to conduct high voltage through a grounded wall. A bushing for a transformer or a reactor may be described as an insulated connection device arranged between a conductor and a winding and the aim of which is to transmit electric current from the conductor to the winding, thus minimizing the risk of a flashover. It is already known that the bushing comprises a built-in capacitance that is used to control the electric field between the conductors of the bushings at a high potential and ground, thus equalizing the field. It is desired to obtain this in order to prevent the occurrence of locally too high fields between the bushing and ground. The magnitude of the built-in capacitance varies, but is typically a few hundred pF. However, the built-in capacitance in the bushing only protects the actual bushing from transient overvoltages.

A bushing for a circuit breaker may be described as an insulated connection device arranged between a conductor and the switch contacts of the circuit breaker. Otherwise, a bushing for a circuit breaker has the same function, object and limitation as described previously in the text as regards a bushing for a transformer or a reactor.

### SUMMARY OF THE INVENTION

The object of the present invention is to provide an improved transient protection device which does not exhibit any of the disadvantages of the prior art solutions.

This object is achieved with a device as defined in claim 1.

According to the invention, the object is achieved in that the device comprises a capacitor connected between the bushing and ground, the capacitance of the capacitor being adapted to reduce the voltage derivative upon transient overvoltages in order thus to achieve a more uniform voltage distribution over the connected electrical component, which may be, for example, a winding or a switch contact, during the transient. By a transient overvoltage is meant a rapid increase of the voltage, caused, for example, by a lightning stroke or a breaker operation.

According to the invention, the built-in capacitor is disposed in the bushing. Because the capacitor is disposed in the bushing, protection is obtained against rapid transients both for the bushing and for the connected electrical component without any external capacitance having to be provided.

One advantage obtained with the invention if the electrical component is part of a transformer or a reactor is that the capacitance does not have to be increased in the upper turns of the winding of the apparatus, as described under the background art. This in turn means that the winding need not be oversized, which leads to reduced production costs and a reduced risk of electrical breakdown in the winding. This, in turn, means that the reliability of service is improved for the device according to the invention. In addition, the advantage is achieved that it will be possible to utilize the already existing bushing to the winding, which means that no further bushing has to be installed, which leads to reduced production costs for the electrical apparatus.

One advantage obtained with the invention if the electrical component is part of a circuit breaker is that the interrupting chamber does not have to be oversized. This entails reduced production costs and a reduced risk of electrical breakdown of the switch contacts, which results in improved reliability of service for the device according to the invention.

According to a preferred embodiment of the invention, the capacitor comprises a plurality of layers of an electrically conductive material wound one above the other, and a plurality of layers of an electrically insulating material wound one above the other. This material advantageously consists of metallized film. By metallized film is meant a plastic foil that is coated with a very thin metal plating. The advantage of this solution is that the capacitance already existing in the bushing may be increased to the desired magnitude and the stress for the connected electrical component thus be reduced when a rapid transient occurs.

According to another embodiment of the invention, the bushing comprises a conductor component adapted to carry electric current through the bushing from the conductor to the electrical component, whereby the metallized film is arranged wound in a plurality of layers around the conductor component. The advantage achieved thereby is that it is easy to calculate how thick the layer of metallized film should be to attain the desired capacitance.

According to a further embodiment of the invention, an insulating tube is arranged around the conductor component and the layers of the metallized film are arranged on the outside of the insulating tube. The insulating tube mounted in the bushing is, for example, made of glass fibre.

According to still another embodiment, the bushing is surrounded by a casing consisting of an insulating material and the metallized film is arranged on the inside of the casing of the bushing. The casing of the bushing is, for example, a porcelain body or a polymer insulant.

According to yet another embodiment of the invention, the bushing comprises a conductor component, wherein said capacitance is connected between the conductor component and ground. The conductor component is adapted to carry electric current through the bushing from the conductor to a connected electrical component, which, for example, is part of a transformer or a high-voltage circuit breaker.

The built-in capacitor advantageously has a magnitude that lies within the interval of 1 nF-1 μF. A capacitance of this order of magnitude is able to reduce the voltage derivative over time in case of transient overvoltages such that a substantially uniform voltage distribution is obtained across the connected electrical component, which, for example, is part of a transformer of a high-voltage circuit breaker.

The built-in capacitor advantageously has a magnitude that lies within the interval of 5 nF-25 nF. This interval is especially suitable for a switch contact in a circuit breaker intended for voltages higher than 1 kV.

The field of use is advantageously adapted for a winding in a transformer or a reactor, intended for voltages higher than 1 kV.

The invention is especially useful for a transient protection device adapted for a winding in a transformer or a reactor intended for voltages higher than 36 kV, since no commercially available protective capacitors for this type of winding exist today.

The field of use is advantageously adapted for a switch contact in a circuit breaker intended for voltages higher than 1 kV.

The invention is especially useful for a transient protection device adapted for a switch contact in a circuit breaker intended for voltages higher than 36 kV.

### BRIEF DESCRIPTION OF THE DRAWINGS

The invention will now be explained in greater detail by describing different embodiments thereof with reference to the accompanying drawings.

FIG. 1 shows an electrical diagram for an installation comprising a transient protection device according to the invention.

FIG. 2 shows a cross section of a bushing comprising a transient protection device according to a first embodiment of the invention.

FIG. 3 shows a cross section of a bushing comprising a transient protection device according to a second embodiment of the invention.

FIG. 4 shows an electrical diagram for an installation comprising a transient protection device according to an alternative embodiment of the invention.

FIG. 5 shows an application of a transient protection device according to the invention.

FIG. 6 shows an alternative application of a transient protection device according to the invention.

### DETAILED DESCRIPTION OF THE DIFFERENT EMBODIMENTS OF THE INVENTION

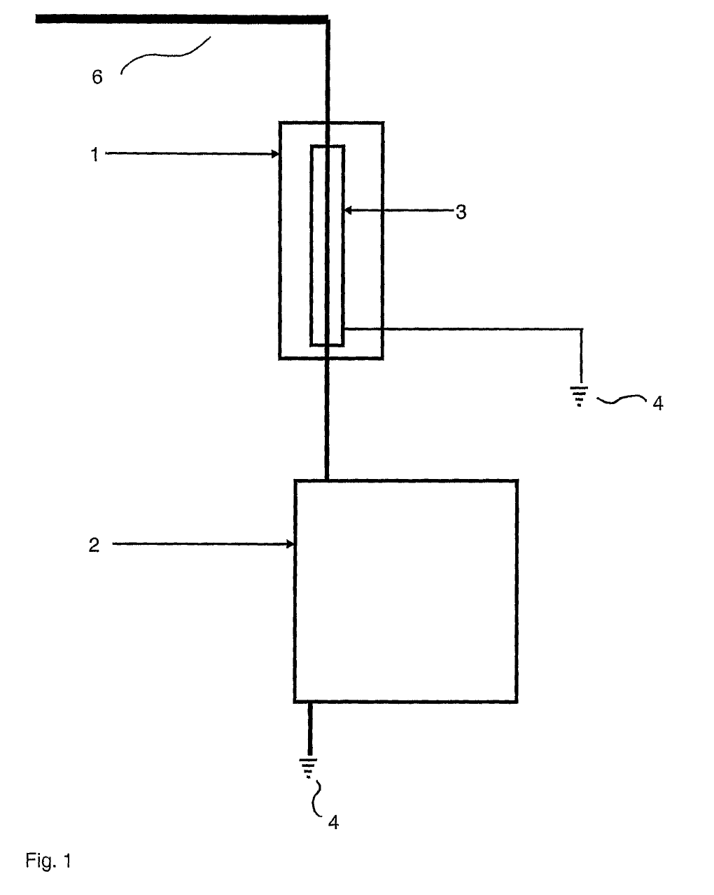

FIG. 1 shows an electrical installation comprising a bushing 1 connected to an electrical component 2 that is connected to ground 4. According to the invention, a capacitor 3 connected to ground is arranged in the bushing 1. The capacitor 3 is intended to protect both the bushing 1 and the electrical component 2, connected to the bushing 1, against transient overvoltages. This is done by arranging a suitable number of layers of metallized film or metal foil in the bushing 1. When a transient arises in the conductor 6, for example caused by a lightning stroke or a rapid breaker operation, the capacitor 3 is charged with a time constant depending on the magnitude of the capacitor 3 and the wave impedance of the conductor 6. Since the desired time constant and the magnitude of the wave impedance of the conductor 6 are known, it is easy to calculate the magnitude of the capacitance of the capacitor 3. An increased time constant (RC) causes the charging of the connected electrical component 2 to proceed more slowly, which means that the voltage derivative (du/dt) is reduced. This further means that the voltage that loads the connected electrical component is considerably reduced, which leads to an equalized voltage distribution across the connected electrical component during the transient. The capacitor 3 has, for example, an order of magnitude of 1 nF-100 nF.

The invention will now be described in various embodiments.

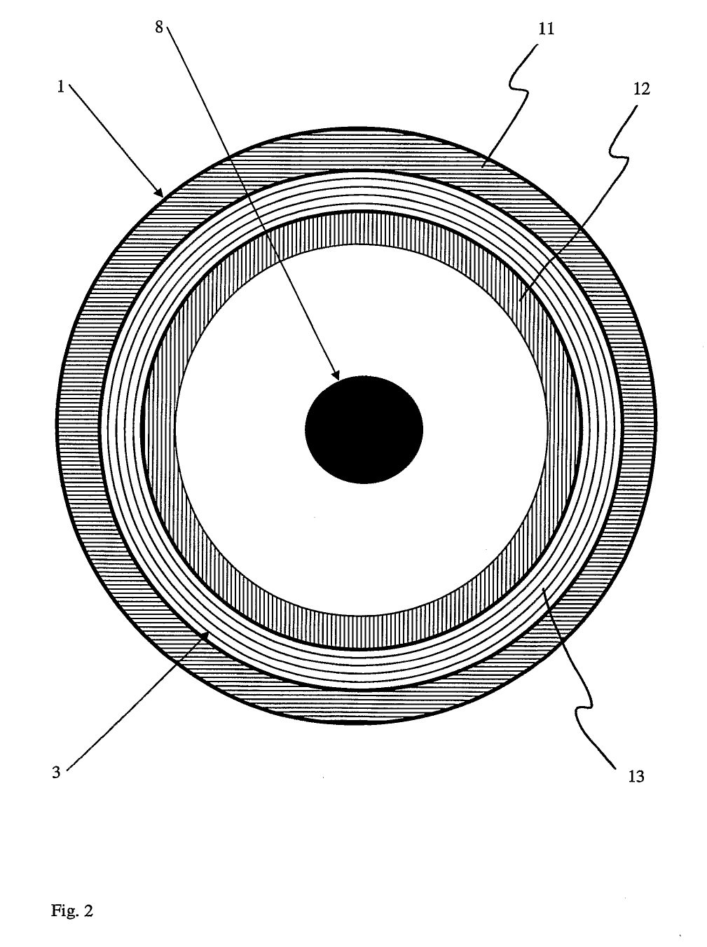

FIG. 2 shows a first embodiment of the invention as viewed in a cross section of the bushing (1) as shown in FIG. 1. The bushing 1 comprises an elongated cylindrical casing 11 that encloses an inner space. A conductor component 8 extends through the centre of the inner space and constitutes an electrical connection between the electrical component and the incoming conductor. A tubular insulating element 12 is arranged between the conductor component 8 and the casing 11. The insulating element 12 is made from some electrical insulating material suitable for the purpose, for example glass fibre. The space between the tubular insulating element 12 and the conductor component 8 is filled with an electrical insulating medium suitable for the purpose, for example SF6. The capacitor 3 according to the invention is disposed between the casing 11 and the insulating element 12 and comprises a suitable number of layers 13 of metallized film wound one above the other, which are wound on the outside of the insulating element 12. The metallized film is arranged as one or more cylinder-shaped tubes arranged in contact with each other in a suitable number on the outside of the insulating element 12. Instead of the capacitor 3 comprising metallized film, it may, for example, comprise metal foil alternating with electrically insulating material.

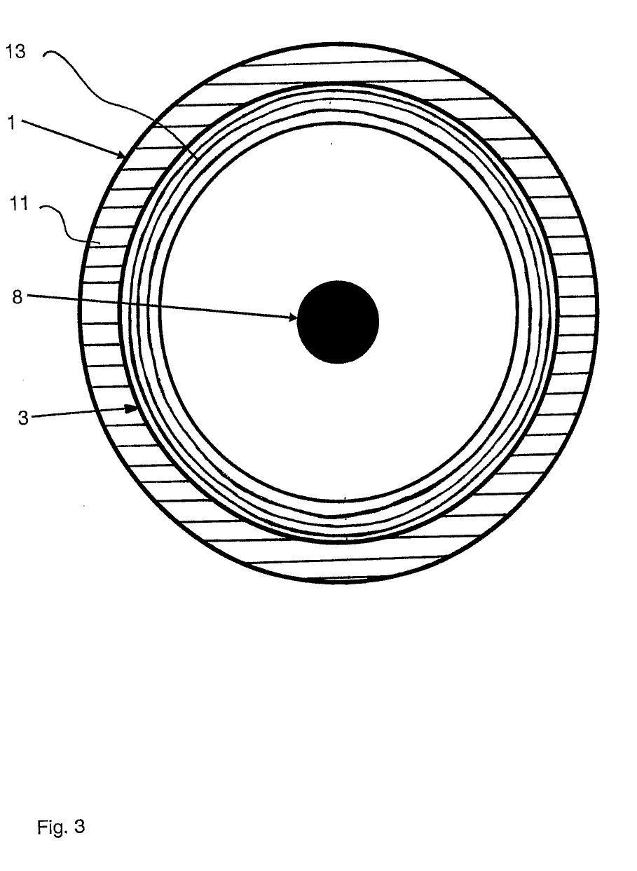

FIG. 3 shows an alternative embodiment of the invention as viewed in a cross section of the bushing 1 shown in FIG. 1. The bushing 1 comprises an elongated cylinder-shaped casing 11 enclosing an inner space. A conductor component 8 extends through the centre of the inner space and constitutes an electrical connection between the electrical component and the incoming conductor. The space between the conductor component 8 and the casing 11 is filled with an electrical insulating medium suitable for the purpose, for example SF6. The capacitor 3 according to the invention is disposed between the casing 11 and the conductor component 8 and comprises a suitable number of layers 13 of metallized film wound one above the other, which are wound on the inside of the casing 11. The desired capacitance is obtained by applying a plurality of layers of metallized film wound one above the other, arranged on the inside of the casing 11 of the bushing 1. Instead of the capacitor 3 comprising metallized film, it may, for example, comprise metal foil alternating with electrically insulating material.

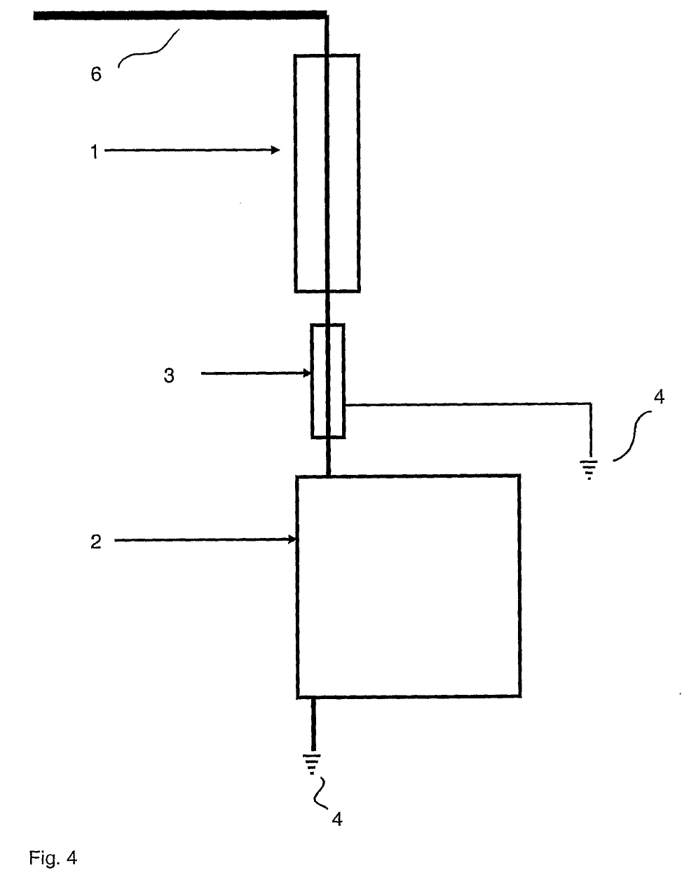

FIG. 4 shows an additional alternative embodiment of the invention, comprising a bushing 1 connected to an electrical component 2 that is connected to ground 4. According to the invention, a capacitor 3 connected to ground 4 is arranged between the bushing 1 and the connected electrical component 2. The capacitor 3 is intended to protect both the bushing 1 and the electrical component 2, connected to the bushing 1, against transient overvoltages. This is done by arranging the capacitor from a suitable number of layers of metallized film or metal foil.

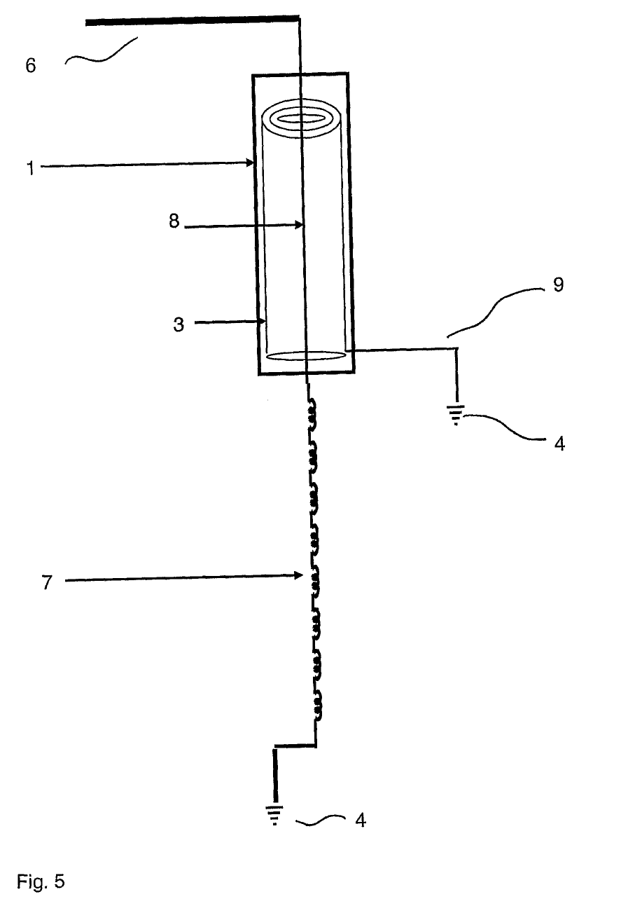

FIG. 5 shows a first application of the invention for a transient protective device for a winding in an electrical apparatus. A conductor 6 is connected to the bushing 1 and a winding 7 is connected to ground 4. According to the invention, a capacitance 3 is arranged from the bushing 1 to ground 4. The conductor 6 is intended, for example, for high-voltage transmission. The winding 7 comprises a plurality of turns and is installed, for example, in a transformer or a reactor. The bushing 1 comprises, inter alia, a conductor component 8 that connects the winding 7 to the incoming conductor 6. According to the invention, the capacitor 3 is arranged by applying a plurality of turns comprising metallized film or metal foil around the conductor component 8 of the bushing. The capacitor 3 is connected to ground 4 by means of a ground cable 9. When a transient arises in the conductor 6, for example by a lightning stroke or a rapid breaker operation, the capacitor 3 is changed with a time constant depending on the magnitude of the capacitor 3 and the wave impedance of the conductor 6. In one example of this, the magnitude of the wave impedance of the conductor 6 is equal to 400Ω and the magnitude of the capacitor 3 is 25 nF. To calculate the time constant (RC), equation Z*C=RC is used, which in the current example means that 400Ω is multiplied by 25 nF, which means that the magnitude of the time constant is 10 μs. Since the desired time constant and the magnitude of the wave impedance of the conductor 6 are known, it is easy to calculate the magnitude of the desired capacitor 3. An increased time constant (RC) causes the charging of the winding 7 to be slower, that is, a longer voltage derivative (du/dt). This means that the voltage that loads the uppermost turns of the winding is considerably reduced and an equalized voltage distribution across the winding 7 is obtained during the transient. The capacitor 3 is, for example, of the order of magnitude of 1 nF-100 nF.

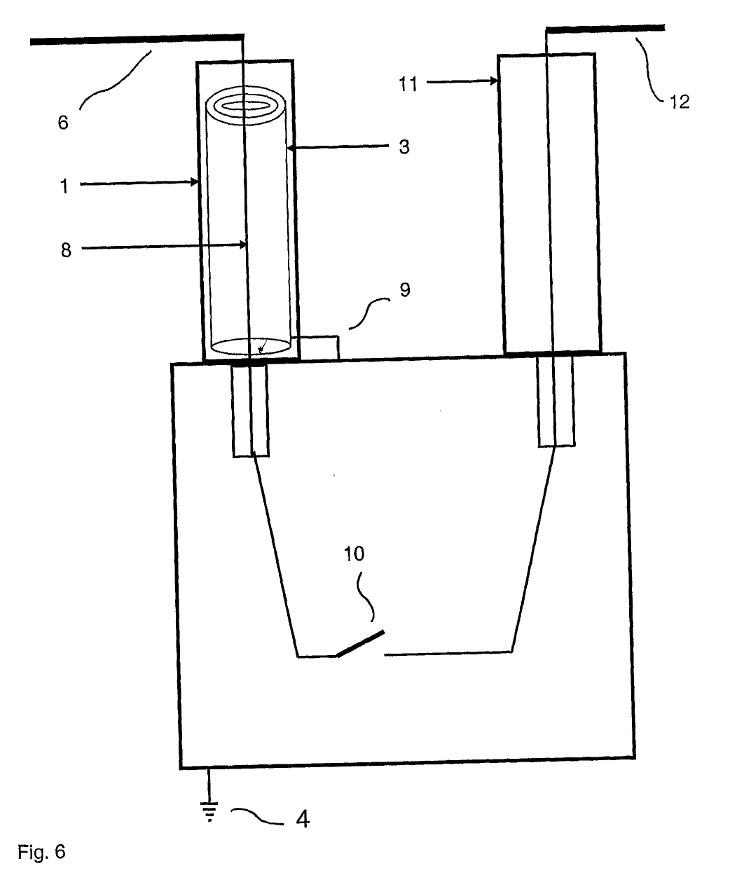

FIG. 6 shows the invention as applied to an electrical apparatus comprising a switch contact, for example a high-voltage circuit breaker. This embodiment comprises a bushing 1 connected to a conductor 6 as well as a switch contact 10. The bushing 1 comprises, inter alia, a conductor component 8 that connects the switch contact 10 to the incoming conductor 6. According to the invention, the capacitor 3 is arranged by applying a plurality of turns consisting of metallized film or metal foil around the conductor component 8 of the bushing. The capacitor 3 is connected to ground 4 by means of a ground cable 9. This embodiment also comprises a bushing 11 that is connected from the switch contact 10, said bushing being further connected to a conductor 12. A capacitor of the same type as mentioned above may be provided in the bushing 11.

1. A device for reduction of the voltage derivative for an electrical component connected to a conductor via an electric bushing comprising a conductor component adapted to carry electric current through the bushing from the conductor to the electrical component, the device comprising:
a capacitor connected between said conductor component and ground, wherein a capacitance of the capacitor is adapted to reduce the voltage derivative over time when transient overvoltages occur, the capacitor being arranged in said bushing.

2. The device according to claim 1, wherein the capacitor comprises a plurality of layers of an electrically conductive material, wound one above an other, and a plurality of layers of an electrically insulating material, wound one above an other.

3. The device according to claim 2, wherein the conductive material together with the insulating material comprise metallized film.

4. The device according to claim 2, wherein said layers are arranged wound around the conductor component.

5. The device according to claim 4, further comprising:
an insulating tube is arranged around the conductor component, wherein said layers are arranged on the outside of said insulating tube.

6. The device according to claim 4, further comprising:
a casing surrounding the bushing, the casing comprising an insulating material, wherein said layers are arranged on the inside of the casing of the bushing.

7. The device according to claim 1, wherein said capacitor is connected between the conductor component and ground.

8. The device according to claim 1, wherein the magnitude of the capacitor is within an interval of 1 nF-1 μF.

9. The device according to claim 1, wherein the electrical component comprises a winding connected to said electric conductor via said bushing, wherein the capacitance of the capacitor is adapted to reduce the voltage derivative over time when transient overvoltages occur, said capacitor being disposed in said bushing.

10. The device according to claim 1, wherein said electrical component comprises a high-voltage circuit breaker and wherein the capacitance of the capacitor is within an interval of 5-25 nF.

11. Use of a device according to claim 1 for reduction of the voltage derivative for a winding in a transformer intended for voltages higher than 1 kV.

12. Use of a device according to claim 1 for reduction of the voltage derivative for a winding in a transformer intended for voltages higher than 36 kV.

13. Use of a device according to claim 1 for reduction of the voltage derivative for a winding in a reactor.

14. Use of a device according to claim 1 for reduction of the voltage derivative for a high-voltage circuit breaker intended for voltages higher than 1 kV.

15. Use of a device according to claim 1 for reduction of the voltage derivative for a high-voltage circuit breaker intended for voltages higher than 36 kV.
